(19) United States
(12) Patent Application Publication
(10) Pub. No.: US 2012/0091898 A1
(43) Pub. Date: Apr. 19, 2012

(54) LIGHT-EMITTING APPARATUS

(75) Inventor: CHUNG-JYH LIN, YongKang (TW)

(73) Assignee: Aussmak Optoelectronics Corp., YongKang City (TW)

(21) Appl. No.: 12/905,006

(22) Filed: Oct. 14, 2010

(51) Int. Cl. H05B 37/02

(52) U.S. Cl. 315/152; 315/297; 315/185 R; 315/157

(57) ABSTRACT

A light-emitting apparatus is electrically connected to a power supply unit. The light-emitting apparatus includes at least one first light-emitting module and a second light-emitting module. The first light-emitting module includes a first light-emitting unit and a first driving circuit, which are electrically connected to each other. The second light-emitting module is electrically connected to the first light-emitting module, and includes a second light-emitting unit and a second driving circuit, which are electrically connected to each other. The first driving circuit adjusts a current passing through the first light-emitting unit in accordance with a first parameter representing the operating state of the second light-emitting module. The second driving circuit adjusts a bypass current bypassing the second light-emitting unit in accordance with a second parameter representing the lighting state of the light-emitting apparatus.

### BACKGROUND OF THE INVENTION

1. Field of Invention

The present invention relates to a light-emitting apparatus.

2. Related Art

LED (light-emitting diode) is a semiconductor component and is used as the light source of indicator and outdoor media board many years ago. Compared with the traditional light source, the LED has the advantages of good efficiency, long lifetime, and strong structure, so that it has been widely used in various kinds of electronic products.

The control method for the light-emitting apparatus that uses the LED as the light source commonly includes a constant voltage control and a constant current control. As shown in FIG. 1A, a conventional light-emitting apparatus 1A, which has the constant voltage control, includes a light-emitting module 11, a capacitor 12, a plurality of resistors 13 and a constant voltage source 14. In order to ensure the signal inputted into the LED to be a constant voltage signal, the capacitor with large capacitance or complex rectifying circuit is usually configured so as to achieve the desired constant voltage.

Although the constant voltage control has the advantage of simpler layout design, it can not provide a stable current for the light-emitting module. Since the LED emits light due to the combination of the electrons and holes to release the excess energy, the change of the applied current can induce a sufficient influence to the lighting property of the LED. In other words, the constant voltage control can not precisely control the lighting property of the LED.

As shown in FIG. 1B, a conventional light-emitting apparatus 1B, which has the constant current control, includes a light-emitting module 11, a capacitor 12, a plurality of resistors 13, a constant current source 15, and a detecting unit 16. In this case, the constant current control can provide a more stable current to the LED. However, in practice, the forward voltages of the LEDs may have difference from each other because of the factors of the manufacturing process and operation temperature. In order to eliminate this difference, the resistor 13 must be used as the current limiter to absorb the power difference caused by the electrical variation so as to stable the current. Thus, the additional power loss may occur.

In the light-emitting apparatus of either the constant voltage control or the constant current control, a power supply unit for providing a stable power source or an element for stabling the voltage or current is necessary. Therefore, it is an important subject of the invention to provide a light-emitting apparatus that can automatically adjust the current applied to each light-emitting unit of the light-emitting apparatus with respect to the variation of the power source, thereby enhancing the power efficiency.

### SUMMARY OF THE INVENTION

In view of the foregoing subject, an objective of the present invention is to provide a light-emitting apparatus that can automatically adjust the current applied to each light-emitting unit of the light-emitting apparatus with respect to the variation of the power source, thereby enhancing the power efficiency.

To achieve the above objective, the invention discloses a light-emitting apparatus, which is electrically connected to a power supply unit and includes at least a first light-emitting module and a second light-emitting module. The first light-emitting module includes a first light-emitting unit and a first driving circuit electrically connected to each other. The second light-emitting module is electrically connected to the first light-emitting module and includes a second light-emitting unit and a second driving circuit electrically connected to each other. The first driving circuit adjusts a current passing through the first light-emitting unit in accordance with a first parameter representing the operating state of the second light-emitting module. The second driving circuit adjusts a bypass current bypassing the second light-emitting unit in accordance with a second parameter representing the lighting state of the light-emitting apparatus.

In one aspect of the invention, the first parameter is varied based on the variation of a voltage drop of the second light-emitting module.

In one aspect of the invention, the first driving circuit includes a bypass unit and a control unit. The bypass unit is electrically connected to the first light-emitting unit. The control unit is electrically connected to the bypass unit for controlling the bypass unit according to the first parameter and at least a reference voltage.

In one aspect of the invention, the second parameter representing the lighting state of the light-emitting apparatus includes current values, voltage values, powers, or lighting output values of the light-emitting units of part or all of the light-emitting modules in the light-emitting apparatus.

In one aspect of the invention, the second driving circuit has a current-bypass path, and the second driving circuit adjusts the bypass current passing through the current-bypass path in accordance with the lighting state of the second light-emitting unit.

In one aspect of the invention, the second driving circuit includes a detecting unit and an adjusting unit. The detecting unit detects the lighting state of the light-emitting apparatus and outputting the second parameter. The adjusting unit is electrically connected to the detecting unit and the second light-emitting unit, and adjusts the bypass current bypassing the second light-emitting unit in accordance with the second parameter.

In one aspect of the invention, the light-emitting apparatus further includes a third light-emitting module, which is electrically connected to the first light-emitting module and has a third light-emitting unit. Herein, each of the first light-emitting unit, the second light-emitting unit and the third light-emitting unit comprises at least one light-emitting diode.

To achieve the above objective, the present invention also discloses a light-emitting apparatus, which is electrically connected to a power supply unit and includes at least a first light-emitting module and a reference voltage control circuit. The first light-emitting module includes a first light-emitting unit and a first driving circuit electrically connected to each other. The first driving circuit adjusts a current passing through the first light-emitting unit in accordance with a first parameter and an output voltage of the first light-emitting unit. The reference voltage control circuit includes a detecting unit and a control unit. The detecting unit detects the lighting state of the light-emitting apparatus and outputs a detecting signal. The control unit controls the reference voltage according to the detecting signal.

In one aspect of the invention, the light-emitting apparatus further includes a second light-emitting module electrically connected to the first light-emitting module and including a second light-emitting unit and a second driving circuit. The second light-emitting unit is electrically connected to the detecting circuit. The second driving circuit has a current-bypass path, and the second driving circuit adjusts the bypass current passing through the current-bypass path according to the detecting signal

In one aspect of the invention, the light-emitting apparatus further includes a third light-emitting module electrically connected to the first light-emitting module and having a third light-emitting unit. Herein, each of the first light-emitting unit, the second light-emitting unit and the third light-emitting unit comprises at least one light-emitting diode.

In one aspect of the invention, the lighting state of the light-emitting apparatus includes current values, voltage values, powers, or lighting output values of the light-emitting units of part or all of the light-emitting modules in the light-emitting apparatus.

As mentioned above, the light-emitting apparatus of the invention can adjust the current dynamically according to the operation state of the light-emitting module and the lighting state of the light-emitting apparatus, so that the unstable lighting of the light-emitting unit caused by the variation of the voltage applied from the power supply unit can be prevented. Accordingly, the invention can automatically adjust the current applied to each light-emitting unit of the light-emitting apparatus with respect to the variation of the power source, thereby enhancing the power efficiency.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of a conventional light-emitting apparatus with the constant voltage control;

FIG. 1B is a schematic diagram of a conventional light-emitting apparatus with the constant current control;

FIG. 2 is a schematic diagram showing a light-emitting apparatus according to a preferred embodiment of the present invention;

FIG. 3 is a circuit diagram showing the light-emitting apparatus according to the preferred embodiment of the present invention; and

FIGS. 4 to 6 are schematic diagrams showing various aspects of the light-emitting apparatus according to the preferred embodiment of the present invention.

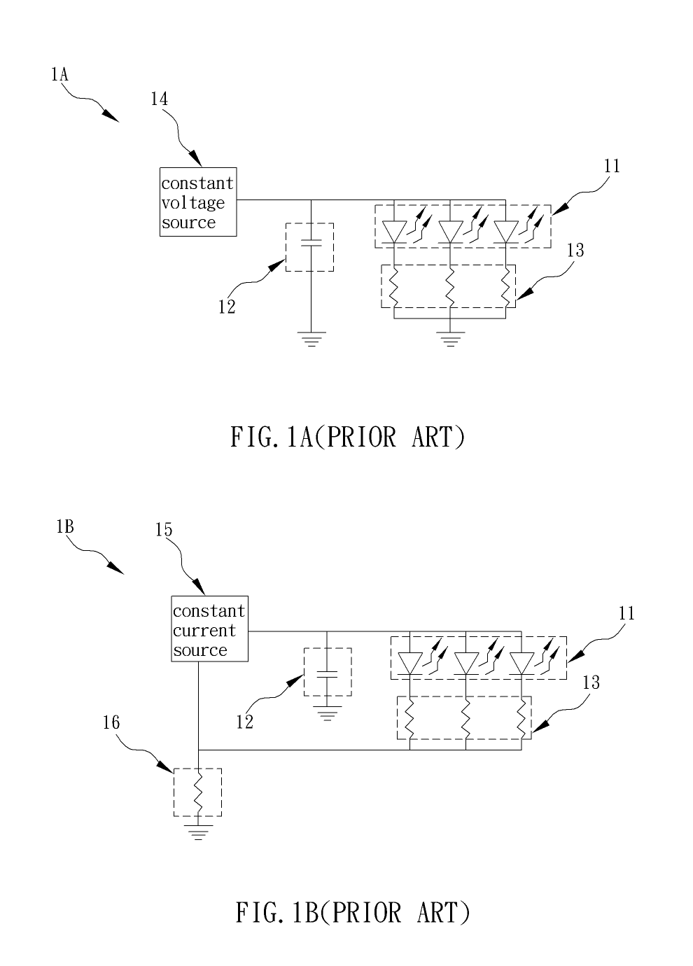

### DETAILED DESCRIPTION OF THE INVENTION

The present invention will be apparent from the following detailed description, which proceeds with reference to the accompanying drawings, wherein the same references relate to the same elements.

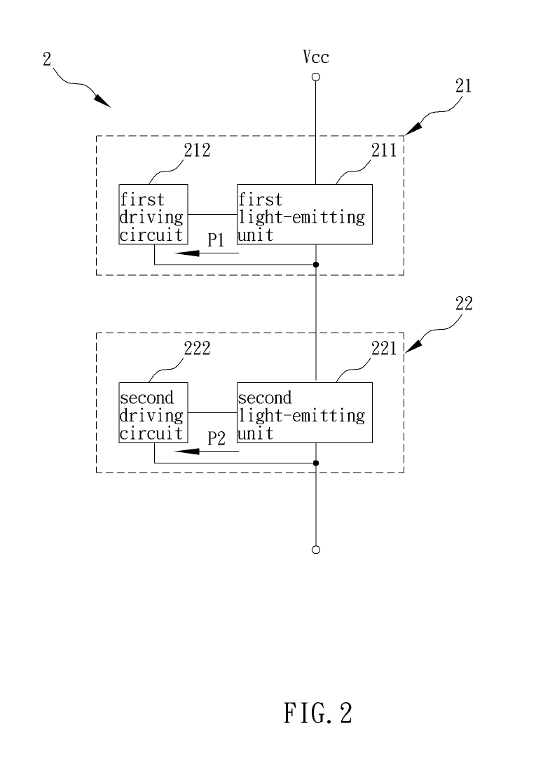

FIG. 2 is a schematic diagram showing a light-emitting apparatus according to a preferred embodiment of the present invention. Referring to FIG. 2, the light-emitting apparatus 2 is electrically connected to a power supply unit V_{CC} and includes a first light-emitting module 21 and a second light-emitting module 22. In this embodiment, the first light-emitting module 21 and the second light-emitting module 22 are connected to the power supply unit V_{CC} in series.

In operation, the power supply unit V_{CC} can provide an AC voltage or a DC voltage. Herein, the AC voltage can be the common city electricity, which is 90V to 250V, or generated by voltage conversion. The DC voltage can be provided by battery or generated by a rectifying circuit after rectifying an AC voltage. To be noted, the voltage level outputted by the battery may vary due to the increase of operation time, and the DC voltage generated by the rectifying circuit may still have ripples. Thus, in practice, the voltage level of these kinds of DC voltage will vary after using for a long time. In other words, the voltage level of the voltage applied by the power supply unit V_{CC} can be varied periodically or randomly.

The first light-emitting module 21 includes a first light-emitting unit 211 and a first driving circuit 212 electrically connected to each other. In this embodiment, the first driving circuit 212 adjusts a current passing through the first light-emitting unit 211 in accordance with a first parameter P1 representing the operating state of the second light-emitting module 22. In addition, the first parameter P1 is varied based on the variation of a voltage drop of the second light-emitting module 22.

The second light-emitting module 22 is electrically connected to the first light-emitting module 21 and includes a second light-emitting unit 221 and a second driving circuit 222 electrically connected to each other. In this embodiment, the second driving circuit 222 adjusts a bypass current bypassing the second light-emitting unit 221 in accordance with a second parameter P2 representing the lighting state of the light-emitting apparatus 2. Herein, the second parameter P2 representing the lighting state of the light-emitting apparatus 2 includes current values, voltage values, powers, or lighting output values of the light-emitting modules 21 and 22.

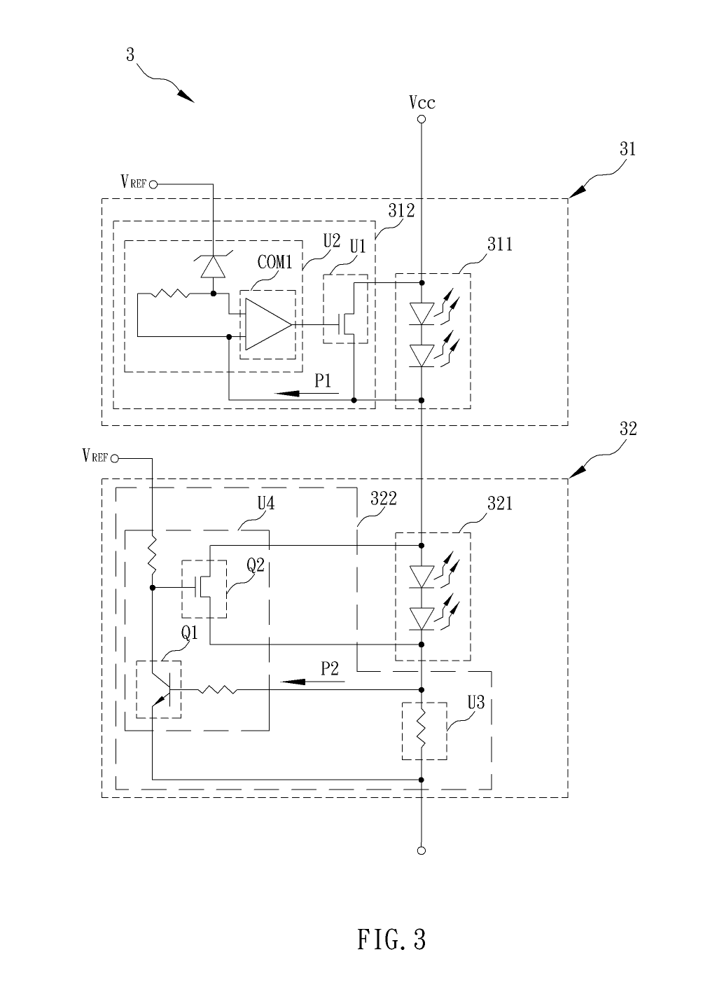

FIG. 3 is a circuit diagram showing the light-emitting apparatus 3 according to the preferred embodiment of the present invention. As shown in FIG. 3, the light-emitting apparatus 3 includes a first light-emitting module 31 and a second light-emitting module 32, which are connected in series.

The first light-emitting module 31 includes a first light-emitting unit 311 and a first driving circuit 312. In this embodiment, the first light-emitting unit 311 includes two LEDs connected in series, and the first driving circuit 312 includes a bypass unit U1 and a control unit U2. The bypass unit U1 is electrically connected to the first light-emitting unit 311 in parallel. In practice, the bypass unit U1 may include a transistor switch, such as a BJT switch or an FET switch.

The control unit U2 is electrically connected to the bypass unit U1. In this embodiment, the control unit U2 includes a comparator circuit COM1, which has two input terminals and one output terminal. The input terminals are connected to a reference voltage V_{REF} and a node between the first and second light-emitting modules 31 and 32, respectively. The output terminal is electrically connected to the bypass unit U1. Accordingly, the control unit U2 can control the bypass unit U1 according to the voltage difference between the reference voltage V_{REF} and the first parameter P1 representing the operation state of the second light-emitting module 32.

The reference voltage V_{REF} can be provided by a controller, a signal generator, or a power supply unit V_{CC}, and moreover, the voltage level of the reference voltage V_{REF} can be different based on the actual requirement of the products.

The second light-emitting module 32 includes a second light-emitting unit 321 and a second driving circuit 322. In this embodiment, the second light-emitting unit 321 includes two LEDs connected in series, and the second driving circuit 322 includes a detecting unit U3 and an adjusting unit U4. The detecting unit U3 detects the lighting state of the light-emitting apparatus 3 and outputs a second parameter P2. In this case, the detecting unit U3 is a resistor. In practice, the detecting unit U3 may include a photo detector, a photodiode, an induction coil, an electro-magnetic induction element, or a magnetic-electric induction element.

The adjusting unit U4 is electrically connected to the detecting unit U3 and the second light-emitting unit 321. In this embodiment, the adjusting unit U4 includes a first switch Q1 and a second switch Q2. The first switch Q1 is electrically connected with the second switch Q2 and the detecting unit U3, and the second switch Q2 is connected with the second light-emitting unit 321 in parallel. The adjusting unit U4 can adjust the bypass current bypassing the second light-emitting unit 321 in accordance with the second parameter P2, and the bypass current flows through the second switch Q2. In other words, the second switch Q2 of the adjusting unit U4 can offer a current-bypass path for the bypass current.

In this embodiment, the control unit U2 further includes a Zener diode, which is electrically connected with the comparator circuit COM1 and the reference voltage V_{REF}. The property of the selected Zener diode may be varied depending on the actual demands. For example, if the forward voltage of the first light-emitting unit 311 is considered, the breakdown voltage value of the selected Zener diode should be equal to or slightly larger than the forward voltage of the first light-emitting unit 311.

To be noted, each of the first and second light-emitting units 311 and 321 of this embodiment includes two LEDs that are connected in series for example. However, in practice, the desired amount of LEDs can be used and the LEDs can be connected in series and/or in parallel.

In practice, when the power supply unit V_{CC} provides the power to the light-emitting apparatus 3, the second switch Q2 of the adjusting unit U4 of the second driving circuit 322 is turned on according to the reference voltage V_{REF}, so that the second light-emitting unit 321 is turned off. At the meantime, the voltage difference between the first reference P1 and the reference voltage V_{REF} received by the input terminals of the comparison circuit COM1 of the control unit U2 is smaller than a predetermined value. Thus, the control unit U2 can control to short the bypass unit U1, so the first light-emitting unit 311 is turned off. Herein, the predetermined value relates to the breakdown voltage of the selected Zener diode.

Then, the detecting unit U3 of the second driving circuit 322 can turn on the first switch Q1 and turn off the second switch Q2 according to the current flowing through the light-emitting apparatus 3, so that the second light-emitting unit 321 is turned on. At the meantime, the first reference P1 is increased to the forward voltage of the second light-emitting unit 321 due to that the second light-emitting unit 321 is turned on. When the voltage level of the power supply unit V_{CC} is increased and excesses the sum of the breakdown voltage of the Zener diode and the forward voltage of the second light-emitting unit 321, the voltage difference between the first reference P1 and the reference voltage V_{REF} is larger than the predetermined value. Accordingly, the control unit U2 can disable the bypass unit U1, so that the first light-emitting unit 311 is turned on.

According to the above-mentioned configuration, the control unit U2 of the first light-emitting module 31 detects the voltage level between the first and second light-emitting modules 31 and 32, and it adjusts the current flowing through the first light-emitting unit 311 by the bypass unit U1 in accordance with the variation of the forward voltage of the second light-emitting module 32. In other words, the voltage detected by the control unit U2 depends on the voltage drops while the second light-emitting unit 321 is bypassed or turned on. In this case, the voltage detected by the control unit U2 is a floating voltage. When the current flowing through the light-emitting apparatus 3 is smaller, the second driving circuit 322 can adjust the current to bypass the second light-emitting unit 321; otherwise, when the current flowing through the light-emitting apparatus 3 is larger, the second driving circuit 322 can adjust the current to flow through the second light-emitting unit 321. Therefore, the light-emitting apparatus 3 of the embodiment can exactly and immediately response the present applied voltage to correspondingly drive the first and second light-emitting units 311 and 321.

To be noted, since the second light-emitting module 32 can maintain the current flowing through the light-emitting apparatus 3, the issue that the light modulator (not shown) may be shut down during the light modulation process as the hold current is too low can be prevented.

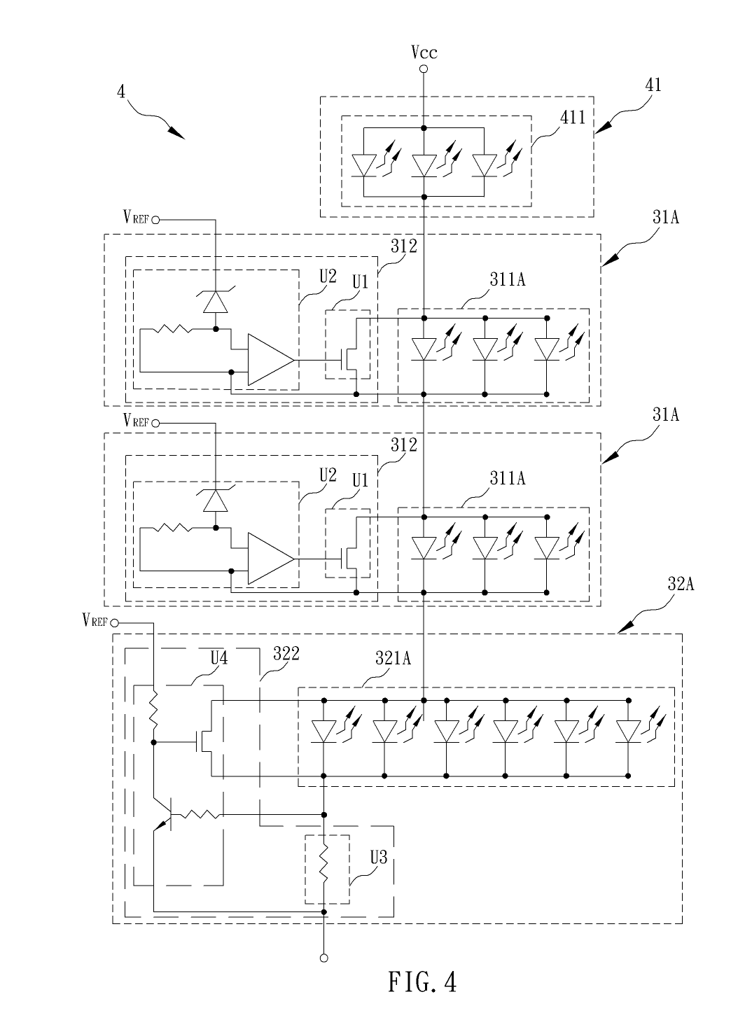

FIG. 4 is a schematic diagram showing an aspect of the light-emitting apparatus according to the preferred embodiment of the present invention. As shown in FIG. 4, a light-emitting apparatus 4 is disclosed and is different from the above-mentioned light-emitting apparatus 3 in that the light-emitting apparatus 4 includes two first light-emitting modules 31A and further includes a third light-emitting module 41. In this embodiment, the first light-emitting modules 31A are connected to each other in series, and the third light-emitting module 41 is electrically connected to the first light-emitting modules 31A. In addition, the third light-emitting module 41 has a third light-emitting unit 411.

To be noted, in the current embodiment, each of the first light-emitting modules 31A, the second light-emitting module 32A, and the third light-emitting module 41 includes, for example but not limited to, three or six LEDs connected in parallel. In practice, the LEDs of the first light-emitting units 311A, the second light-emitting units 321A, and the third light-emitting units 411 may include at least two kinds of LEDs with different dimensions. Moreover, the above-mentioned LED can be an LED die or an LED package.

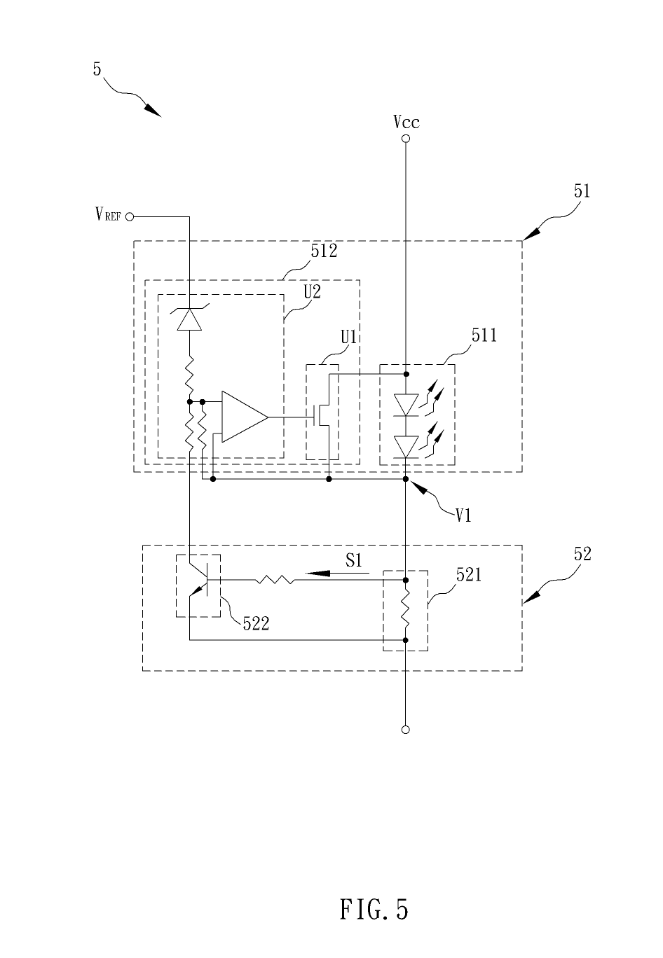

FIG. 5 is a schematic diagram showing another aspect of the light-emitting apparatus according to the preferred embodiment of the present invention. As shown in FIG. 5, a light-emitting apparatus 5 is disclosed and is electrically connected to a power supply unit V_{CC}. The light-emitting apparatus 5 includes a first light-emitting module 51 and a reference voltage control circuit 52.

The first light-emitting module 51 includes a first light-emitting unit 511 and a first driving circuit 512 electrically connected to each other. In this embodiment, the first driving circuit 512 includes a bypass unit U1 and a control unit U2, and the bypass unit U1 is connected to the first light-emitting unit 511 in parallel.

The control unit U2 is electrically connected to the bypass unit U1 for receiving a reference voltage V_{REF} and an output voltage V1 of the first light-emitting unit 511. Then, the control unit U2 can control the bypass unit U1 in accordance with the output voltage V1 and the reference voltage V_{REF}, and thus adjust the current passing through the first light-emitting unit 511.

The reference voltage control circuit 52 includes a detecting unit 521 and a control unit 522. In this embodiment, the detecting unit 521 detects the lighting state of the light-emitting apparatus 5 and outputs a detecting signal S1. Then, the control unit 522 of the reference voltage control circuit 52 controls the reference voltage V_{REF} according to the detecting signal S 1. Herein, the lighting state of the light-emitting apparatus 5 includes the current value, voltage value, power, or lighting output values of the light-emitting apparatus 5. In addition, the control unit 522 may include a transistor switch, such as a BJT switch or an FET switch.

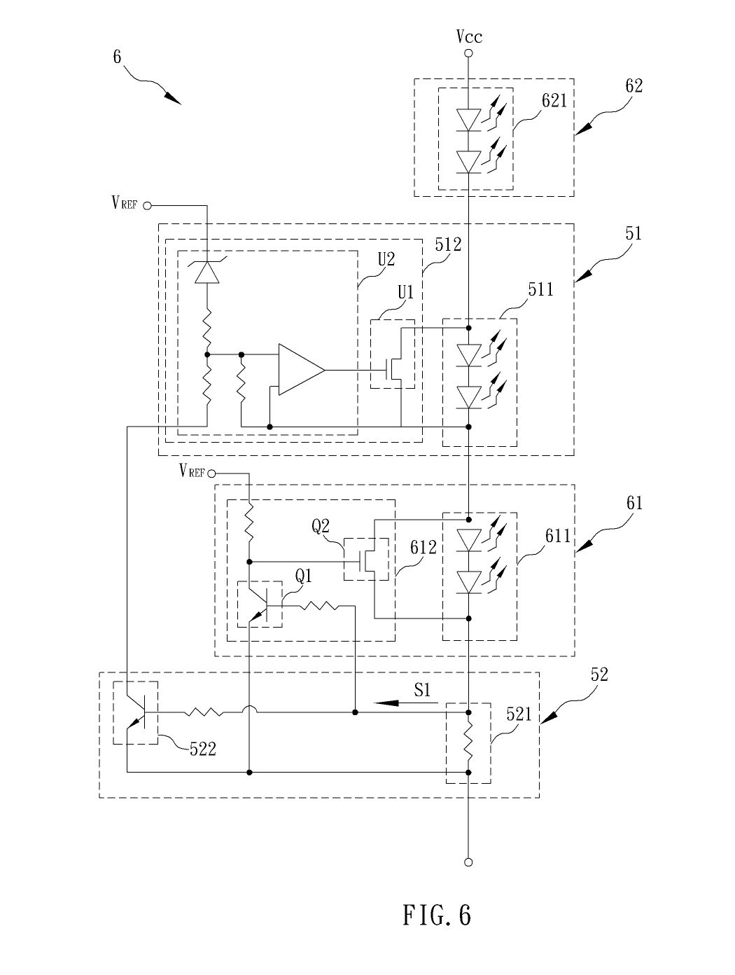

FIG. 6 is a schematic diagram showing another aspect of the light-emitting apparatus according to the preferred embodiment of the present invention. As shown in FIG. 6, a light-emitting apparatus 6 is disclosed and is different from the above-mentioned light-emitting apparatus 5 in that the light-emitting apparatus 6 further includes a second light-emitting module 61 and a third light-emitting module 62.

The second light-emitting module 61 is electrically connected with the first light-emitting module 51 and includes a second light-emitting unit 611 and a second driving circuit 612. In this embodiment, the second light-emitting unit 611 is electrically connected to the detecting unit 521, and the second driving circuit 612 includes a first switch Q1 and a second switch Q2. The first switch Q1 is electrically connected with the second switch Q2 and the detecting unit 521, and the second switch Q2 is connected to the second light-emitting unit 611 in parallel. The second driving circuit 612 can adjust the bypass current bypassing the second light-emitting unit 611 in accordance with the detecting signal S 1. In practice, the second switch Q2 of the second driving circuit 612 can provide a current-bypass path for the bypass current. The third light-emitting module 62 is electrically connected to the first light-emitting module 51 and includes a third light-emitting unit 621.

In this embodiment, each of the first, second and third light-emitting units 511, 611 and 621 has two LEDs for example. In addition, the LEDs of the first, second and third light-emitting units 511, 611 and 621 may include at least two kinds of LEDs with different dimensions. Moreover, the above-mentioned LED can be an LED die or an LED package.

In practice, the detecting unit 521 of the reference voltage control circuit 52 detects the current flowing through the light-emitting apparatus 6, and then the control unit 522 controls the control unit U2 of the first driving circuit 512. In addition, the first switch Q1 of the second driving circuit 612 controls the second switch Q2 according to the detecting signal S1. When the current flowing through the light-emitting apparatus 6 decreases, the control unit 522 is turned off and thus the control unit U2 turns off the bypass unit U1 to turn on the first light-emitting unit 511. Since the first light-emitting unit 511 is turned on, the current flowing through the light-emitting apparatus 6 becomes smaller, so that the light modulator (not shown) is shut down immediately due to the insufficient hold current. Thus, the unstable lighting during the light modulation process as the hold current is too low can be prevented.

According to the above embodiments, the light-emitting apparatus of the invention can be applied to vehicle indicators, lamps, traffic lights, media boards, electronic apparatuses, display devices, etc.

In summary, the light-emitting apparatus of the invention can adjust the current dynamically according to the operation state of the light-emitting module and the lighting state of the light-emitting apparatus, so that the unstable lighting of the light-emitting unit caused by the variation of the voltage applied from the power supply unit can be prevented. Accordingly, the invention can automatically adjust the current applied to each light-emitting unit of the light-emitting apparatus with respect to the variation of the power source, thereby enhancing the power efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light-emitting apparatus, which is electrically connected to a power supply unit, comprising:
at least a first light-emitting module comprising a first light-emitting unit and a first driving circuit electrically connected to each other; and
a second light-emitting module electrically connected to the first light-emitting module and comprising a second light-emitting unit and a second driving circuit electrically connected to each other;
wherein the first driving circuit adjusts a current passing through the first light-emitting unit in accordance with a first parameter representing the operating state of the second light-emitting module, and the second driving circuit adjusts a bypass current bypassing the second light-emitting unit in accordance with a second parameter representing the lighting state of the light-emitting apparatus.

2. The light-emitting apparatus according to claim 1, wherein the first parameter is varied based on the variation of a voltage drop of the second light-emitting module.

3. The light-emitting apparatus according to claim 1, wherein the first driving circuit comprises:
a bypass unit electrically connected to the first light-emitting unit; and
a control unit electrically connected to the bypass unit for controlling the bypass unit according to the first parameter and at least a reference voltage.

4. The light-emitting apparatus according to claim 3, wherein the control unit has a comparator circuit having two input terminals and one output terminal, the first parameter and the reference voltage are inputted to the input terminals respectively, and the output terminal is electrically connected to the bypass unit.

5. The light-emitting apparatus according to claim 1, wherein the second parameter representing the lighting state of the light-emitting apparatus comprises the current value, voltage value, power, or lighting output values of the light-emitting units of part or all of the light-emitting modules in the light-emitting apparatus.

6. The light-emitting apparatus according to claim 1, wherein the second driving circuit has a current-bypass path, and the second driving circuit adjusts the bypass current passing through the current-bypass path in accordance with the lighting state of the second light-emitting unit.

7. The light-emitting apparatus according to claim 1, wherein the second driving circuit comprises:
a detecting unit for detecting the lighting state of the light-emitting apparatus and outputting the second parameter; and
an adjusting unit electrically connected to the detecting unit and the second light-emitting unit for adjusting the bypass current bypassing the second light-emitting unit in accordance with the second parameter.

8. The light-emitting apparatus according to claim 1, wherein when the light-emitting apparatus comprises a plurality of first light-emitting modules, the first light-emitting modules are connected in series.

9. The light-emitting apparatus according to claim 1, further comprising:
a third light-emitting module electrically connected to the first light-emitting module and having a third light-emitting unit.

10. The light-emitting apparatus according to claim 9, wherein each of the first light-emitting unit, the second light-emitting unit and the third light-emitting unit comprises at least one light-emitting diode.

11. The light-emitting apparatus according to claim 10, wherein the light-emitting diodes of the first light-emitting unit, the second light-emitting unit and the third light-emitting unit comprise at least two different dimensions.

12. A light-emitting apparatus, which is electrically connected to a power supply unit, comprising:
at least a first light-emitting module comprising a first light-emitting unit and a first driving circuit electrically connected to each other, wherein the first driving circuit adjusts a current passing through the first light-emitting unit in accordance with a first parameter and an output voltage of the first light-emitting unit; and
a reference voltage control circuit comprising a detecting unit and a control unit, wherein the detecting unit detects the lighting state of the light-emitting apparatus and outputs a detecting signal, and the control unit controls the reference voltage according to the detecting signal.

13. The light-emitting apparatus according to claim 12, further comprising:
a second light-emitting module electrically connected to the first light-emitting module and comprising a second light-emitting unit and a second driving circuit, wherein the second light-emitting unit is electrically connected to the detecting circuit.

14. The light-emitting apparatus according to claim 13, wherein the second driving circuit has a current-bypass path, and the second driving circuit adjusts the bypass current passing through the current-bypass path according to the detecting signal.

15. The light-emitting apparatus according to claim 13, further comprising:
a third light-emitting module electrically connected to the first light-emitting module and having a third light-emitting unit.

16. The light-emitting apparatus according to claim 15, wherein each of the first light-emitting unit, the second light-emitting unit and the third light-emitting unit comprises at least one light-emitting diode.

17. The light-emitting apparatus according to claim 16, wherein the light-emitting diodes of the first light-emitting unit, the second light-emitting unit and the third light-emitting unit comprise at least two different dimensions.

18. The light-emitting apparatus according to claim 12, wherein the lighting state of the light-emitting apparatus comprises the current value, voltage value, power, or lighting output values of the light-emitting apparatus.

19. The light-emitting apparatus according to claim 12, wherein the first driving circuit comprises:
a bypass unit electrically connected to the first light-emitting unit; and
a control unit electrically connected to the bypass unit for controlling the bypass unit according to the output voltage and the reference voltage.
